(19) United States
(12) Patent Application Publication
(10) Pub. No.: US 2018/0062146 A1
(43) Pub. Date: Mar. 1, 2018

(54) THIN CELL AND CELL-MOUNTING DEVICE

(71) Applicant: Panasonic Intellectual Property Management Co. Ltd., Osaka (JP)

(72) Inventors: YUYA ASANO, Osaka (JP); TOMOHIRO UEDA, Osaka (JP); YOKO SANO, Osaka (JP)

(21) Appl. No.: 15/558,553

(22) PCT Filed: Feb. 15, 2016
(86) PCT No.: PCT/JP2016/000755

§ 371 Date: Sep. 14, 2017

(30) Foreign Application Priority Data
Mar. 30, 2015 (JP) 2015-069412

(51) Int. Cl. H01M 2/26; H01M 4/587; H01M 4/525; H01M 2/02; H01M 10/0565; H01M 10/0585

(52) U.S. Cl. CPC H01M 2/26; H01M 4/587; H01M 4/525; H01M 2/0275; H01M 2300/004; H01M 10/0585; H01M 2220/30; H01M 2300/0085; H01M 10/0565

(57) ABSTRACT

A thin cell including a sheet-like first electrode, a sheet-like second electrode, a separator disposed between the first and second electrode, a first lead connected to the first electrode and extending to the outside of a housing, and a second lead connected to the second electrode and extending to the outside of the housing. The first electrode and the second electrode respectively include a rectangular current collector sheet and an active material layer attached to a surface thereof. Furthermore, at least one of the current collector sheets has a tab extending from a part of one side thereof in a plane direction of the current collector sheet and being connected to a lead, the tab forming a flat spring structure that expands and contracts in the plane direction.

### PRIORITY

This is a National Stage Application under 35 U.S.C. § 371 of International Application PCT/JP2016/000755, with an international filing date of Feb. 15, 2016, which claims priority to Japanese Patent Application No. 2015-069412 filed on Mar. 30, 2015. The entire disclosures of International Application PCT/JP2016/000755 and Japanese Patent Application No. 2015-069412 are hereby incorporated herein by reference.

### TECHNICAL FIELD

The present invention relates to a thin cell including a sheet-like electrode assembly, and a cell-mounting device mounting the same.

### BACKGROUND ART

In recent years, thin cells have been used as power sources for small electronic equipment such as biological wearable devices, cellular phones, voice recording and playing-back devices, wristwatches, video and still cameras, liquid crystal displays, electronic calculators, IC cards, temperature sensors, hearing aids, and pressure-sensitive buzzers. Such thin cells are required to have flexibility. For example, a thin cell to be mounted to a biological wearable device or a wearable portable terminal is required to be deformed in response to the movement of a living body. Thus, a thin cell having a housing made of a thin and flexible laminate film has been proposed (see Patent Literature 1).

### CITATION LIST

### Patent Literature

PTL 1: Japanese Patent Application Unexamined Publication No. 2013-48041

### SUMMARY OF THE INVENTION

An electrode assembly of a thin cell includes a sheet-like first electrode and a sheet-like second electrode; a separator disposed between the first and second electrodes; a first lead connected to the first electrode and extending to the outside of a housing; and a second lead connected to the second electrode and extending to the outside of the housing. The first and second electrodes each includes a current collector sheet and an active material layer attached to a surface of the current collector sheet. A tab, which extends in a plane direction of the current collector sheet, is provided to a part of one side of the current collector sheet. To the tab, a lead is connected. The lead is allowed to extend to the outside of the housing.

Since it is premised that a thin cell is highly flexible, the thin cell needs to maintain battery performance even when it is deformed. On the other hand, a main body and a lead of the thin cell are fixed to electronic equipment. Therefore, a load due to bending is concentrated on a connection site between the lead and the tab. Consequently, when the thin cell is excessively bent, or bending is repeated frequently beyond the assumption, the tab may be broken and an electric current may be blocked.

In view of the foregoing, one aspect of the present invention relates to a thin cell including a sheet-like electrode assembly, a non-aqueous electrolyte with which the electrode assembly is impregnated, and a housing for hermetically housing the electrode assembly and the non-aqueous electrolyte. The electrode assembly includes a sheet-like first electrode, a sheet-like second electrode, and a separator disposed between the first electrode and the second electrode. The first electrode includes a first current collector sheet, and a first active material layer attached to a surface of the first current collector sheet. The second electrode includes a second current collector sheet, and a second active material layer attached to a surface of the second current collector sheet. The first current collector sheet includes a first tab extending from a part of a side of the first current collector sheet in the plane direction of the first current collector sheet, and/or the second current collector sheet includes a second tab extending from a part of a side of the second current collector sheet in the plane direction of the second current collector sheet. The first tab and/or the second tab forms a first spring structure that expands and contracts in an extending direction thereof.

Another aspect of the present invention relates to a thin cell including a sheet-like electrode assembly, a non-aqueous electrolyte with which the electrode assembly is impregnated, and a housing for hermetically housing the electrode assembly and the non-aqueous electrolyte. The electrode assembly includes a sheet-like first electrode, a sheet-like second electrode, and a separator disposed between the first electrode and the second electrode, and further includes a first lead connected to the first electrode and extending to the outside of the housing, and/or a second lead connected to the second lead and extending to the outside of the housing. The first electrode includes a first current collector sheet and a first active material layer attached to a surface of the first current collector sheet. The second electrode includes a second current collector sheet and a second active material layer attached to a surface of the second current collector sheet. The first lead and/or second lead forms a second spring structure that expands and contracts in the extending direction thereof.

Still another aspect of the present invention relates to a cell-mounting device including the thin cell as mentioned above; flexible electronic equipment to be driven by electric power supplied from the thin cell. The thin cell and the electronic equipment are integrated together to form a sheet.

According to the present invention, when a thin cell and a cell-mounting device are excessively bent, or when bending is repeated frequently beyond the assumption, a load applied to the tab is relieved. Thus, breaking of the tab is suppressed.

### BRIEF DESCRIPTION OF THE DRAWINGS

FIG. 1 is a perspective view showing an example of a cell-mounting device (a biological wearable device) including a thin cell.

FIG. 2 is a perspective view showing an example of an appearance of the device which has been deformed.

FIG. 3 is a partially cut-away plan view of a housing of a thin cell in accordance with a first exemplary embodiment.

FIG. 4 is longitudinal sectional view of a region including a first tab as a principal part of the thin cell.

FIG. 5 is a plan view showing a first electrode (a) and a second electrode (b) of the thin cell.

FIG. 6 is a plan view of a modified example of a principal part of an electrode of the thin cell in accordance with the first exemplary embodiment.

FIG. 7 is a plan view of a principal part of an electrode of a thin cell in accordance with a second exemplary embodiment.

FIG. 8 is a plan view of a principal part of electrodes (a) to (c) of a thin cell in accordance with a third exemplary embodiment.

FIG. 9 is a plan view of a principal part of an electrode of a thin cell in accordance with a fourth exemplary embodiment.

FIG. 10 is a plan view of a principal part of an electrode of a thin cell in accordance with a fifth exemplary embodiment.

FIG. 11 is a plan view of a principal part of an electrode of a thin cell in accordance with a sixth exemplary embodiment.

### DETAILED DESCRIPTION OF THE PREFERRED EMBODIMENT

A thin cell in accordance with one exemplary embodiment of the present invention includes a sheet-like electrode assembly, a non-aqueous electrolyte with which the electrode assembly is impregnated, and a housing for hermetically housing the electrode assembly and the non-aqueous electrolyte. The electrode assembly includes a sheet-like first electrode, a sheet-like second electrode, and a separator disposed between the first electrode and the second electrode. The first electrode includes a first current collector sheet, and a first active material layer attached to a surface of the first current collector sheet. The second electrode includes a second current collector sheet, and a second active material layer attached to a surface of the second current collector sheet. The first current collector sheet includes a first tab extending from a part of a side of the first current collector sheet in a plane direction of the first current collector sheet, and/or the second current collector sheet includes a second tab extending from a part of a side of the second current collector sheet in a plane direction of the second current collector sheet. Herein, the first tab and/or the second tab forms a first spring structure that expands and contracts in the extending direction of the first tab and/or the second tab. When the first tab and/or the second tab has the first spring structure, a load applied to the tab is greatly relieved. At least one of the first current collector sheet and the second current collector sheet may have a corresponding tab (first tab or second tab). Furthermore, at least one of the first tab and the second tab may have the first spring structure.

A thin cell may further include a first lead connected to the first tab and led out to the outside of the housing, and/or a second lead connected to the second tab and led out to the outside of the housing.

The first tab may include a multiple-line structure including a plurality of conductive paths for allowing the first current collector sheet and the first lead to have electrical continuity to each other. Furthermore, the second tab may include a multiple-line structure including a plurality of conductive paths for allowing the second current collector sheet and the second lead to have electrical continuity to each other. The tab having a multiple-line structure may have a seamless structure that is cut out from the same conductive sheet material as that of the current collector sheet, or may be formed of wires and the like.

The first lead and/or the second lead may form a second spring structure that expands and contracts in a leading-out direction of the first and/or second lead. The leading-out direction is the same as the extending direction of the first and/or second tab. Thus, the tab and the lead can be integrated together to form a spring structure.

The thin cell may not have a lead. In this case, a part of the first tab may form a first lead portion led out to the outside of the housing, and/or a part of the second tab may form a second lead portion led out to the outside of the housing.

It is preferable that the first current collector sheet and the first tab and/or the second current collector sheet and the second tab have a seamless structure cut out from the same conductive sheet material. Such a structure can be formed easily, and therefore advantageously reduce the manufacturing cost.

The first spring structure can be obtained by providing the first tab and/or the second tab with a slit. Such a structure can be formed further easily, and, therefore, further advantageously reduce the manufacturing cost. The slit may be formed in a direction intersecting the extending direction of the first tab and/or the second tab.

The thin cell may further include a resin film that covers at least a part of the first tab and/or the second tab. Thus, strength of the tab is improved, and breaking of the tab is very unlikely to occur. Furthermore, the thin cell may further include a resin film that covers at least a part of the first lead and/or the second lead. Thus, the strength of the tab and the lead is increased, and breaking of the tab and the lead is very unlikely to occur.

A thin cell of another exemplary embodiment of the present invention includes a sheet-like electrode assembly, a non-aqueous electrolyte with which the electrode assembly is impregnated, and a housing for hermetically housing the electrode assembly and the non-aqueous electrolyte. The electrode assembly includes a sheet-like first electrode, a sheet-like second electrode, a separator disposed between the first electrode and the second electrode, and a first lead connected to the first electrode and extending to the outside of the housing and/or a second lead connected to the second electrode and extending to the outside of the housing. The first electrode includes a first current collector sheet and a first active material layer attached to the surface of the first current collector sheet. The second electrode includes a second current collector sheet and a second active material layer attached to the surface of the second current collector sheet. The first lead and/or second lead forms a second spring structure that expands and contracts in the extending direction of the first lead and/or second lead. When the first lead and/or the second lead has the second spring structure, a load applied to the lead is greatly relieved. At least one of the first electrode and the second electrode may include a corresponding lead (first lead or second lead). Furthermore, at least one of the first lead and the second lead may have the second spring structure.

When at least a part of the non-aqueous electrolyte forms a gel electrolyte, the gel electrolyte can bond between the first active material layer and the separator, and bond between the second active material layer and the separator. Thus, the strength of the electrode assembly is increased. On the other hand, however, a load applied to the tab and/or the lead is easily increased. In such a case, the first spring structure and the second spring structure exhibit a remarkable effect of relieving the load applied to the tab and the lead.

The cell-mounting device in accordance with the exemplary embodiment of the present invention includes the above-mentioned thin cell, and flexible electronic equipment driven by electric power supplied from the thin cell. The thin cell and the electronic equipment are integrated together to form a sheet. Examples of the electronic equipment to be integrated together with the thin cell to form a sheet include a biological wearable device or a wearable portable terminal, a portable telephone, a recording and playing-back device, a wristwatch, a video and still camera, a liquid crystal display, an electronic calculator, an IC card, a temperature sensor, a hearing aid, a pressure-sensitive buzzer, and the like. In particular, since the biological wearable device is used in a state in which it is in close contact with a living body, flexibility is required. Examples of the biological wearable device include a biological information measuring device, an iontophoretic dermal administration device, and the like.

The thickness of the thin cell is not particularly limited, and is preferably 3 mm or less, further preferably 2 mm or less, or 1.5 mm or less in view of the flexibility. The thickness of the sheet-like cell-mounting device may be larger than the thickness of the thin cell. However, from the similar viewpoint as mentioned above, the thickness is preferably 3 mm or less. Note here that when the thin cell and the cell-mounting device have a thickness of about 5 mm or less, relatively excellent flexibility can be obtained. The lower limit of the thickness of the thin cell and the cell-mounting device is, for example, 50 μm.

Configuration of the electrode assembly is not particularly limited, and, for example, the configuration can include the followings.

An electrode assembly having the simplest structure includes a first electrode, a second electrode, and a separator interposed between the first electrode and the second electrode (first electrode/second electrode). In this case, the first electrode is a single-sided electrode including a first current collector sheet and a first active material layer attached to one surface of the first current collector sheet. The second electrode is also a single-sided electrode including a second current collector sheet and a second active material layer attached to one surface of the second current collector sheet.

An electrode assembly having the next simplest structure includes a pair of first electrodes disposed at the outermost side of the electrode assembly, one second electrode disposed between the pair of first electrodes, and separators each interposed between one of the first electrodes and the second electrode (first electrode/second electrode/first electrode). In this case, the first electrode is single-sided electrode including a first current collector sheet and a first active material layer attached to one surface of the first current collector sheet. On the other hand, the second electrode is a double-sided electrode including a second current collector sheet and second active material layers attached to both surfaces of the second current collector sheet.

A thin cell having another structure includes a pair of first electrodes (single-sided electrode) and two or more second electrodes (double-sided electrode), a first electrode (double-sided electrode) disposed between the pair of second electrodes, and separators each interposed between the first electrode and the second electrode (for example, first electrode/second electrode/first electrode/second electrode/first electrode).

Hereinafter, the exemplary embodiments of the present invention are described in more detail. However, the following exemplary embodiments are not construed to limit the scope of the present invention.

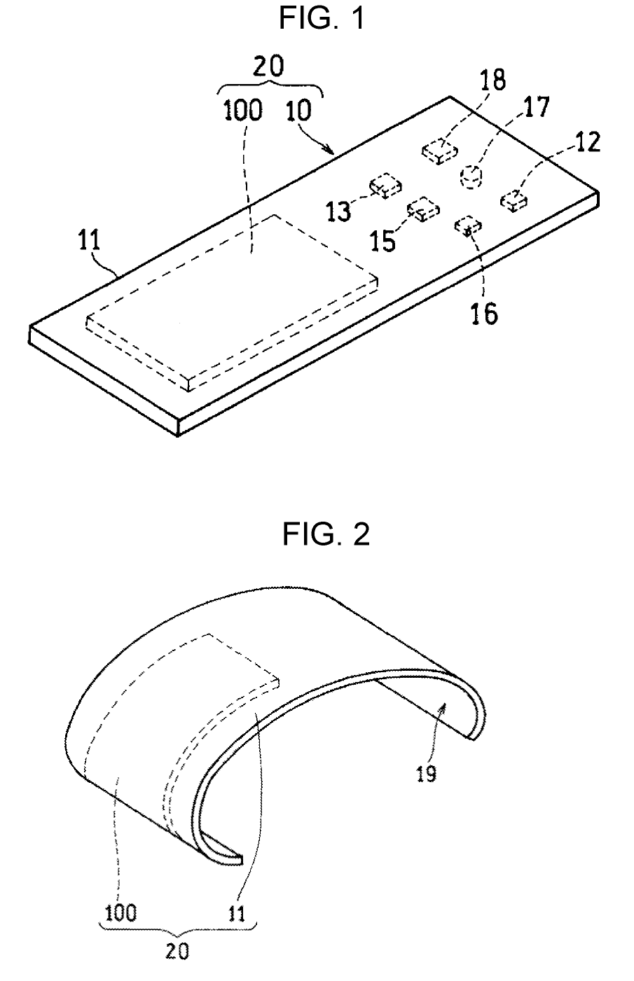

FIG. 1 is a perspective view showing an example of cell-mounting device 20 including a biological information measuring device as electronic equipment. FIG. 2 shows an example of an appearance of a case in which the device has been deformed.

Biological information measuring device 10 includes sheet-like holding member 11 configured to hold component elements of device 10 and a thin cell. Holding member 11 is made of a flexible material. Elements such as button switch 12, temperature sensor 13, pressure-sensitive element 15, memory 16, information transmitter 17, and controller 18 are embedded in holding member 11. Thin cell 100 is housed inside holding member 11. In other words, thin cell 100 and biological information measuring device 10 are integrated together as one sheet to produce cell-mounting device 20. For holding member 11, for example, an electrically insulative resin material can be used. Applying, for example, adhesive agent 19 having adhesive strength to one main surface of cell-mounting device 20 enables cell-mounting device 20 to be placed around the wrist, ankle, neck, and other parts of a user.

Temperature sensor 13 outputs signals indicating a body temperature of a user to controller 18. Pressure-sensitive element 15 outputs signals indicating blood pressure and pulse of a user to controller 18. Memory 16 stores information corresponding to the signals that have been output. Information transmitter 17 converts necessary information into radio waves and then radiates the radio waves. Controller 18 controls an operation of each portion of biological information measuring device 10. Switch 12 turns on and off biological information measuring device 10.

### First Exemplary Embodiment

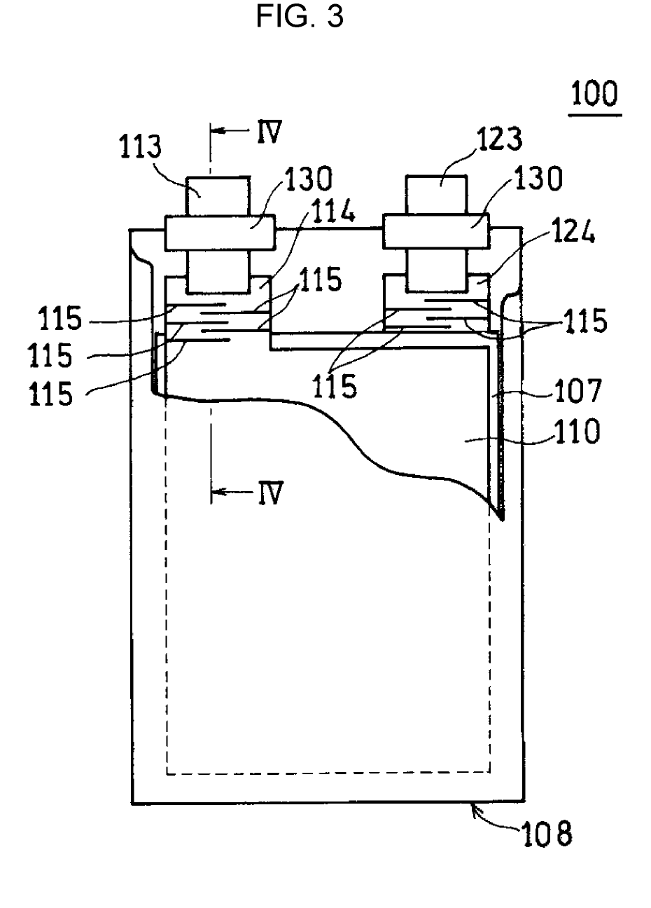

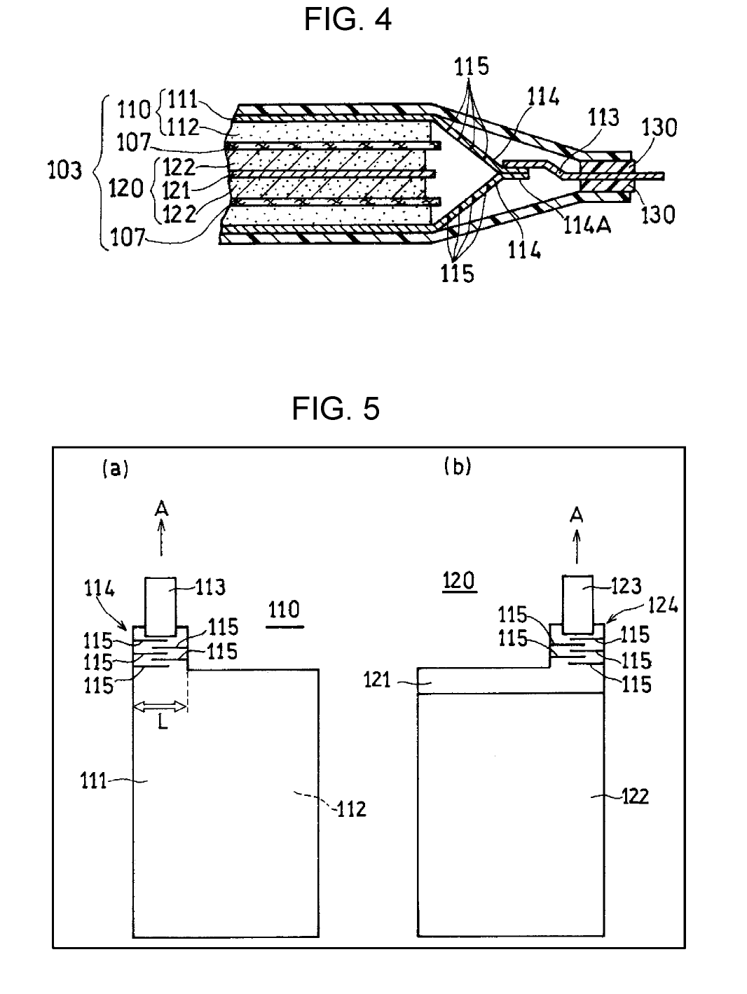

Next, a thin cell in accordance with a first exemplary embodiment of the present invention is described with reference to FIGS. 3 and 4. FIG. 3 is a partially cut-away plan view of a housing of a thin cell, and FIG. 4 is longitudinal sectional view conceptually showing a principal part of the electrode assembly of the thin cell. Note here that FIG. 4 corresponds to a sectional view taken along line IV-IV of the thin cell shown in FIG. 3.

Thin cell 100 includes electrode assembly 103, non-aqueous electrolyte (not shown), and housing 108 for housing electrode assembly 103 and the non-aqueous electrolyte. Electrode assembly 103 includes a pair of first electrodes 110 located at the outer side, second electrode 120 disposed between the pair of first electrodes 110, and separators 107 interposed between each first electrode 110 and second electrode 120. First electrode 110 includes first current collector sheet 111 and first active material layer 112 attached to one surface of first current collector sheet 111. Second electrode 120 includes second current collector sheet 121 and second active material layers 122 attached to both surfaces of second current collector sheet 121. The pair of first electrodes 110 are disposed with second electrode 120 sandwiched therebetween such that first active material layer 112 and second active material layer 122 face each other with separator 107 interposed therebetween.

First tab 114 extends from one side of first current collector sheet 111. First tab 114 is cut out from the same conductive sheet material as that of first current collector sheet 111. First current collector sheet 111 and first tab 114 may be different members, but it is preferable that first current collector sheet 111 and first tab 114 form the seamless structure. First tabs 114 of the pair of first electrodes 110 are stacked on each other and electrically connected to each other by, for example, welding. Thus, assembly tab 114A is formed. First lead 113 is connected to assembly tab 114A (see FIG. 4). First lead 113 is led out to the outside of housing 108.

Similarly, second tab 124 extends from one side of second current collector sheet 121. Second tab 124 is cut out from the same conductive sheet material as that of second current collector sheet 121. Second lead 123 is connected to second tab 124, and second lead 123 is led out to the outside of housing 108.

End portions of first lead 113 and second lead 123 derived to the outside of housing 108 function as positive electrode outside terminal or negative electrode outside terminal, respectively. It is desirable that seal member 130 for enhancing sealing property be provided between housing 108 and each lead. For seal member 130, a thermoplastic resin can be used.

In FIG. 3, the electrode assembly is generally shown in rectangle, but the shape of the electrode assembly is not limited to this shape. The shape of the electrode excluding the tab may be any shapes as long as they have a straight portion in a part (a part provided with a tab). Examples of the shape include a rectangle (including a square), a trapezoid, a parallelogram, a substantially elliptic shape having a straight portion in a part, a substantially rectangle having at least one round corner, a substantially trapezoid, a substantially parallelogram, or the like. From the viewpoint of productivity, a rectangle or a substantially rectangle is preferable. When the electrode assembly has a rectangle or a substantially rectangle, the length ratio of the long side to the short side satisfies, for example, long side short side=1:1 to 8:1.

Similarly, the shape of the tab is not particularly limited. Examples of the shape of the tab include a rectangle (including a square), a trapezoid, a parallelogram, a semicircle, a semi-ellipse, a rectangle whose tip end is an arc shape, a substantially rectangle having at least one round corner, a substantially trapezoid, a substantially parallelogram, or the like.

Next, structures of the first electrode and the second electrode in accordance with the first exemplary embodiment are described with reference to FIG. 5.

FIG. 5(a) is a plan view of the first electrode, and FIG. 5(b) is a plan view of the second electrode.

First electrode 110 includes first current collector sheet 111 and first active material layer 112 attached to one surface (a rear surface in FIG. 5) of first current collector sheet 111. First tab 114 extends from a part of one side of first current collector sheet 111 in the plane direction of first current collector sheet 111.

Similarly, second electrode 120 includes second current collector sheet 121 and second active material layers 122 attached to both surfaces of second current collector sheet 121. Second tab 124 extends from a part of one side of second current collector sheet 121 in the plane direction of second current collector sheet 121. The shapes of second current collector sheet 121 and the shape of second tab 124 are approximately symmetrical to the shapes of first current collector sheet 111 and first tab 114.

A seamless-structured integrated product of a current collector sheet and a tab can be produced by cutting out from the same conductive sheet material. An active material layer is not formed on the tab. The tab is an exposed part of the conductive sheet material of the same as the current collector sheet. One end of the lead is connected to the tab by, for example, welding. The other end of the lead is led out to the outside of housing 108. When the current collector sheet and the tab are formed of different members, the current collector sheet and the tab can be connected to each other by, for example, welding or using a conductive adhesive agent.

The tab is provided with a plurality of slits 115 in a direction intersecting the extending direction of the tab. The direction intersecting the extending direction of the tab is preferably a width direction of the tab, in other words, a direction having an angle (absolute value) of 0 to 15° with respect to the side of a current collector sheet provided with the tab. Thus, the tab forms a planar first spring structure that expands and contracts in the extending direction (a direction of the arrow A).

When a length in the width direction of the tab is defined as L, the length of slit 115 may be, for example, 0.5 L or more and 0.75 L or less, preferably 0.80 L or less, and more preferably 0.85 L or less from one end in the width direction of the tab. Thus, it is possible to form a first spring structure securing the strength of the tab and having high elasticity.

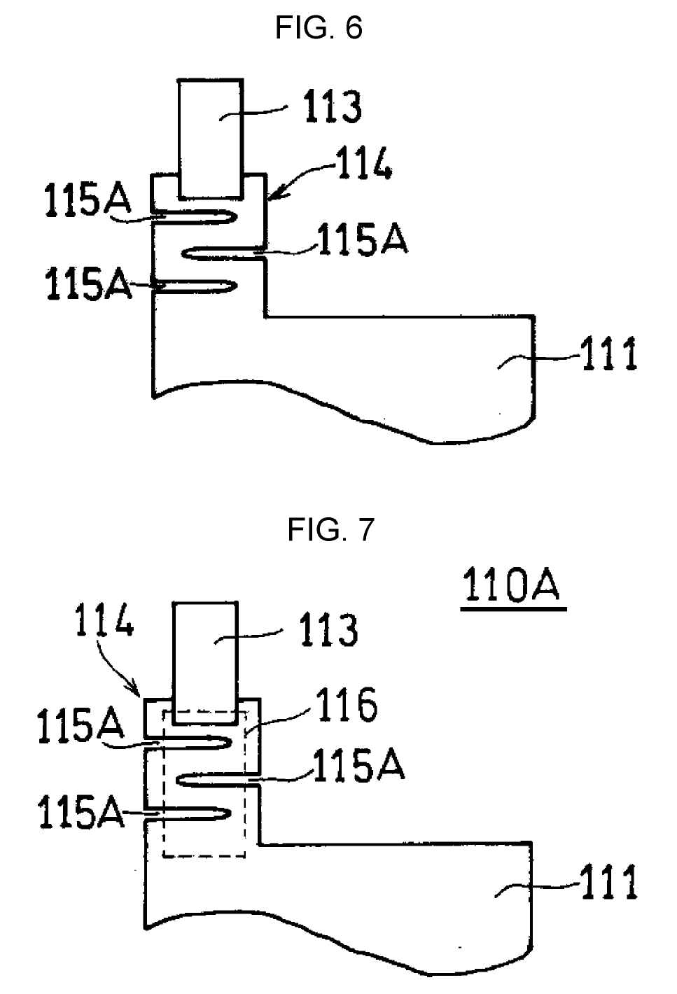

The form of slit 115 is not limited as long as the strength of the tab can be secured. Slit 115 may be a linear opening with little width as shown in FIG. 5. The linear opening can be formed by a simple operation, for example, only drawing a line on the tab using a cutter, or cutting the tab from at least one side of the upper and lower direction. The number of slits is not limited, and it may be one, but preferably two or more from the viewpoint of increase in elasticity. Furthermore, as shown in the modified example of FIG. 6, as the slit, thin elongated cut-away part 115A extending from one end to the other end side in the width direction of the tab. Cut-away part 115A desirably has a curved outline as shown in the drawing, but it may be an elongated rectangle or a wedge-shaped cut-away part.

### Second Exemplary Embodiment

FIG. 7 is a plan view of a principal part of first electrode 110A of a thin cell in accordance with a second exemplary embodiment. The configuration of the principal part of the second electrode is substantially the same as that of the first electrode.

In this exemplary embodiment, at least a part of first tab 114 having a first spring structure is covered with resin film 116. Except for this point, the principal part in accordance with this exemplary embodiment has the same structure as that of, for example, the first exemplary embodiment. In an example shown in the drawing, the resin film is conceptually shown by a dotted line.

Resin film 116 is flexible and expands and contracts to some extent. Therefore, even when the first spring structure is covered with resin film 116, the expanding and contracting property of the first spring structure is not largely inhibited. On the other hand, when at least a part of the tab having the first spring structure is covered with resin film 116, mechanical strength of the tab can be largely improved.

For resin film 116, it is preferable to use a tape material having resistance to a non-aqueous electrolyte. Among them, an adhesive tape having an adhesive agent on one surface thereof is preferable. Such an adhesive tape can be easily attached to the tab having the first spring structure. Examples of the base material of the adhesive tape include fluorocarbon resin, polyimide, polyphenylene sulfide, polyethersulfone, polyethylene, polypropylene, polyethylene terephthalate, and the like. As the adhesive agent, adhesive agents including rubber components such as butyl rubber and polyisobutylene rubber, and adhesive agents including acrylic resin can be used.

Alternatively, at least a part of the tab may be covered with resin film 116 having thermal welding property, and resin film 116 may be welded to the tab by heating. Examples of resin having thermal welding property include polypropylene, polyethylene, and the like.

### Third Exemplary Embodiment

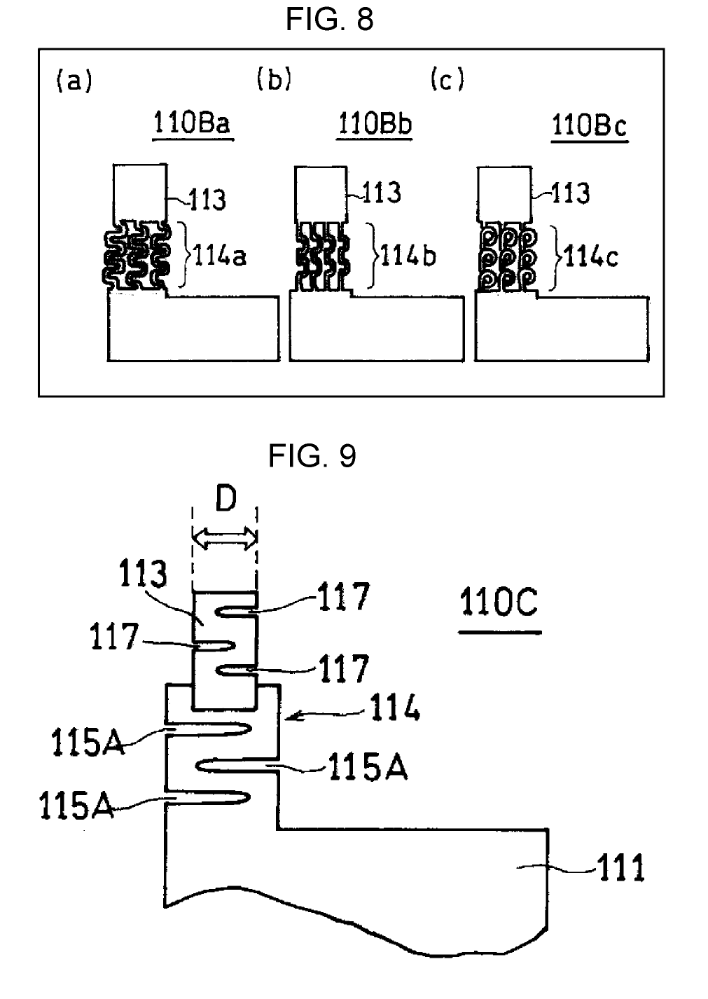

FIG. 8 is a plan view of principal parts of electrodes 110Ba, 110Bb, and 110Bc of a thin cell in accordance with a third exemplary embodiment. The configuration of the principal part of the second electrode is substantially similar to that of the first electrode.

In this exemplary embodiment, a first spring structure is formed of first tab 114 including a multiple-line structure having a plurality of conductive paths 114a, 114b, and 114c allowing first current collector sheet 111 and first lead 113 to have electrical continuity to each other. Except for this point, the principal part in accordance with this exemplary embodiment has a similar structure to that of, for example, the first exemplary embodiment.

The plurality of conductive paths 114a, 114b, and 114c can be formed of wires made of, for example, a conductive material. Each wire has bending parts to have elasticity. When such wires are used, it is necessary to connect the wire to the current collector sheet and the lead by welding or other techniques, or using a conductive adhesive agent. On the other hand, since the first spring structure formed of wire is highly elastic, a load to a connection part between the wire and the current collector sheet and/or the lead can be minimized.

Since the plurality of conductive paths 114a and 114b forms a flat spring structure, spring wirings as a plurality of conductive paths together with a current collector sheet can be also cut out from the same conductive sheet material. In this case, a seamless structure of the current collector sheet and the tab (spring-shaped wiring) can be obtained.

### Fourth Exemplary Embodiment

FIG. 9 is a plan view of a principal part of first electrode 110C of a thin cell in accordance with a fourth exemplary embodiment. A configuration of the principal part of the second electrode is approximately similar to that of the first electrode.

In this exemplary embodiment, not only first tab 114 but also first lead 113 has a second spring structure that expands and contracts in the leading-out direction (in other words, the extending direction of the tab). Except for this point, the principal part in accordance with this exemplary embodiment has the similar structure to, for example, that of the first exemplary embodiment.

The second spring structure can be obtained by, for example, providing a lead with a plurality of slits 117 in a direction intersecting the leading-out direction. Herein, the direction intersecting the leading-out direction is preferably a width direction of the lead, in other words, a direction having an angle (absolute value) of 0 to 15° with respect to a side of a current collector sheet provided with the tab. This makes it possible to form a spring structure in which the tab and the lead are integrated with each other and which has very high elasticity.

When a length in the width direction of the lead is defined as D, a length of slit 117 is, for example, 0.5 D or more, and 0.75 D or less, preferably 0.80 D or less, and more preferably 0.85 D or less from one end of the lead in the width direction of the lead. Thus, it is possible to form the second spring structure securing the strength of the lead and having high elasticity.

The form of slit 117 is not limited as long as the strength of the lead can be secured. The form of slit 117 may be according to the slit formed in the tab described in the first exemplary embodiment. For example, as shown in the drawing, slit 117 may be a cut-away part having a small width, or a linear opening with little width. Furthermore, according to the second exemplary embodiment, a resin film is used, and at least a part of the lead, together with the tab or instead of the tab, may be covered with the resin film.

### Fifth Exemplary Embodiment

FIG. 10 is a plan view of a principal part of first electrode 110D of a thin cell in accordance with a fifth exemplary embodiment. A configuration of the principal part of the second electrode is approximately similar to the configuration of the first electrode.

In this exemplary embodiment, first tab 114 having a first spring structure also functions as a lead. Except for this point, a principal part in accordance with this exemplary embodiment has, for example, the similar structure to that of the first exemplary embodiment. In other words, first tab 114 has the first spring structure, and first lead portion 113A. Such a tab can be formed by increasing the length in the extending direction of the tab as compared with the other exemplary embodiments.

### Sixth Exemplary Embodiment

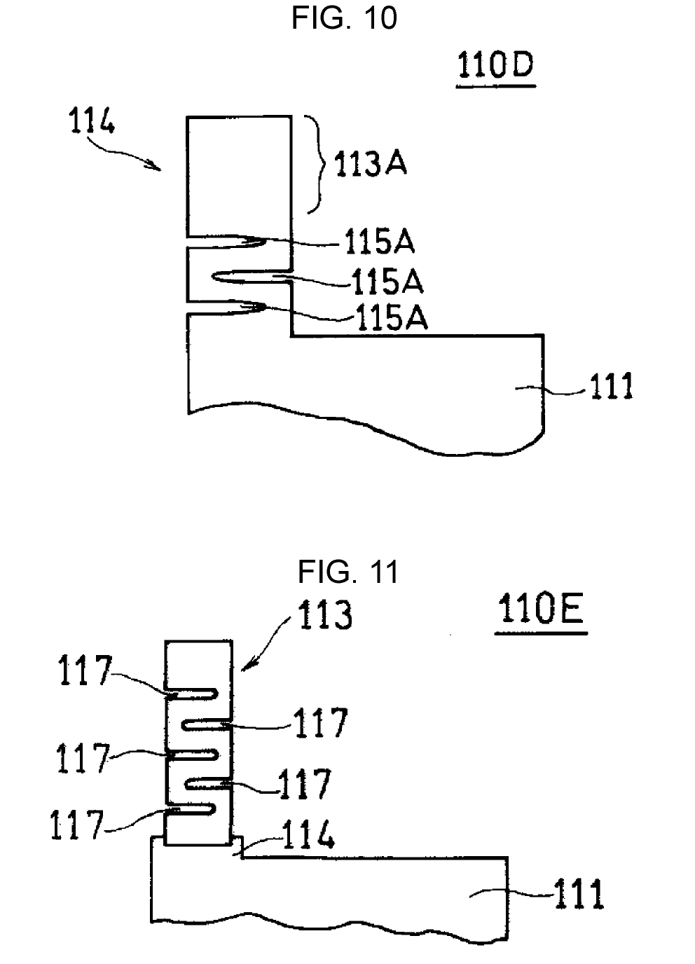

FIG. 11 is a plan view of a principal part of first electrode 110E of a thin cell in accordance with a sixth exemplary embodiment. A configuration of the principal part of the second electrode is approximately similar to the configuration of the first electrode.

In this exemplary embodiment, first tab 114 does not have a first spring structure, and only first lead 113 forms a second spring structure that expands and contracts in the leading-out direction (in other words, the extending direction of the tab). Except for this point, the principal part in accordance with this exemplary embodiment has, for example, a similar structure to that of the fourth exemplary embodiment. Therefore, the second spring structure may be formed according to the fourth exemplary embodiment. Thus, only by processing the lead in a spring structure, the effect that is the same as or similar to that of the fourth exemplary embodiment can be expected. Furthermore, according to the second exemplary embodiment, a resin film is used, and at least a part of the lead may be covered with the resin film. At this time, as shown in the drawing, the length in the extending direction of first tab 114 may be reduced. Thus, the strength of first tab 114 can be enhanced.

Next, electrodes, a lead, a separator, a non-aqueous electrolyte, a housing, and the like, constituting an electrode assembly are described.

### Negative Electrode

A negative electrode includes a negative electrode current collector sheet as a first or second current collector sheet, and a negative electrode active material layer as a first or second active material layer. For the negative electrode current collector sheet, a metal film, a metal foil, and the like, are used. It is preferable that a material of the negative electrode current collector sheet is at least one selected from the group consisting of copper, nickel, titanium, an alloy thereof, and stainless steel. The thickness of the negative electrode current collector sheet is, for example, 5 to 30 μm.

The negative electrode active material layer includes a negative electrode active material, and includes a binder and a conductive agent if necessary. The negative electrode active material layer may be a deposited film formed by gas-phase deposition (for example, vapor deposition). Examples of the negative electrode active material include Li metal, metal or an alloy that electrochemically reacts with Li, a carbon material (for example, graphite), a silicon alloy, silicon oxide, and the like. The thickness of the negative electrode active material layer is, for example, 1 to 300 μm.

### Positive Electrode

A positive electrode includes a positive electrode current collector sheet as a first or second current collector sheet, and a positive electrode active material layer as the first or second active material layer. For the positive electrode current collector sheet, a metal film, a metal foil, and the like, are used. It is preferable that a material of the positive electrode current collector sheet is, for example, at least one selected from the group consisting of silver, nickel, palladium, gold, platinum, aluminum, and an alloy thereof, and stainless steel. The thickness of the positive electrode current collector sheet is preferably, for example, 1 to 30 μm.

The positive electrode active material layer includes a positive electrode active material and a binder, and a conductive agent, if necessary. The positive electrode active material is not particularly limited. When the thin cell is a secondary cell, a lithium-containing composite oxide such as LiCoO₂ and LiNiO₂ can be used. When a thin cell is a primary cell, manganese dioxide, fluorinated carbon (fluorinated graphite), a lithium-containing composite oxide, and the like, can be used. The thickness of the positive electrode active material layer is preferably, for example, 1 to 300 μm.

Examples of the conductive agent to be contained in the active material layer include graphite and carbon black, and the like. An amount of the conductive agent is, for example, 0 to 20 parts by mass with respect to 100 parts by mass of the active material. Examples of the binder to be contained in the active material layer include fluorocarbon resin, acrylic resin, rubber particles, and the like. An amount of the binder is, for example, 0.5 to 15 parts by mass with respect to 100 parts by mass of the active material.

### Separator

For the separator, resin microporous film or non-woven fabric is preferably used. Preferable examples of materials (resin) for the separator include polyolefin (polyethylene, polypropylene, etc.), polyamides, polyamide-imide, or the like. The thickness of the separator is, for example, 8 to 30 μm.

### Lead

A negative electrode lead and a positive electrode lead are connected to a negative electrode current collector sheet or a positive electrode current collector sheet, respectively, by, for example, welding. Preferable examples of the negative electrode lead include a copper lead, a copper alloy lead, a nickel lead, and the like. Preferable examples of the positive electrode lead include a nickel lead, an aluminum lead, and the like.

### Wire

A material of wire connected to the negative electrode in accordance with the third exemplary embodiment is preferably at least one selected from the group consisting of copper, nickel, titanium, an alloy thereof and stainless steel. Furthermore, examples of the material of wire connected to the positive electrode include silver, nickel, palladium, gold, platinum, aluminum, an alloy thereof, and stainless steel.

### Non-Aqueous Electrolyte

When a thin cell is a lithium ion cell, a non-aqueous electrolyte is preferably a mixture of lithium salt and a non-aqueous solvent for dissolving lithium salt. Examples of the lithium salt include LiClO₄, LiBF₄, LiPF₆, LiCF₃SO₃, LiCF₃CO₂, imide salts, and the like. Examples of the non-aqueous solvent include cyclic carbonic acid esters such as propylene carbonate, ethylene carbonate, and butylene carbonate; chain carbonic acid esters such as diethyl carbonate, ethyl methyl carbonate, and dimethyl carbonate; and cyclic carboxylic acid esters such as γ-butyrolactone and γ-valerolactone.

It is preferable that at least a part of a non-aqueous electrolyte with which the electrode assembly is impregnated forms a gel electrolyte. The gel electrolyte is preferably present at least in an interface region between each active material layer and each separator. When a gel electrolyte is present in the interface region between the active material layer and the separator, bonding property between the electrode and the separator is improved. It is preferable that the gel electrolyte is also present inside the air gaps of each active material layer and/or in pores of each separator.

The gel electrolyte includes, for example, a non-aqueous electrolyte, and resin swollen with the non-aqueous electrolyte. As the resin swollen with the non-aqueous electrolyte, a fluorocarbon resin including a polyvinylidene fluoride unit is preferable. The fluorocarbon resin including a polyvinylidene fluoride unit easily holds a non-aqueous electrolyte, and is easily gelled.

Examples of the fluorocarbon resin including a polyvinylidene fluoride unit include polyvinylidene fluoride (PVdF), a copolymer containing a polyvinylidene fluoride (VdF) unit and a hexafluoropropylene (HFP) unit (PVdF-HFP), and a copolymer containing a polyvinylidene fluoride (VdF) unit and a trifluoroethylene (TFE) unit, and the like. It is preferable that the amount of the polyvinylidene fluoride unit contained in the fluorocarbon resin containing a polyvinylidene fluoride unit is 1 mol % or more such that the fluorocarbon resin is easily swollen with the non-aqueous electrolyte.

When the gel electrolyte is disposed in an interface region between the active material layer and the separator, the resin swollen with the non-aqueous electrolyte is applied to, for example, a surface of the active material layer and/or a surface of the separator in a form of, for example, a thin film. Thereafter, the active material layer and the separator are stacked on each other via a resin coating film, and the resulting stack or an electrode assembly is impregnated with a non-aqueous electrolyte. Thus, resin is swollen and wetted with the non-aqueous electrolyte, and a gel electrolyte is formed in the interface region. It is preferable that when a fluorocarbon resin including a polyvinylidene fluoride unit is used for the gel electrolyte, the amount of the resin contained in the coating film is 1 to 30 g/m² per unit surface area of an interface region between the active material layer and the separator (in other words, per unit surface area of the active material layer or the separator).

A housing is formed of, for example, a laminate film including a water vapor barrier layer, and a resin layer formed on both surfaces of the water vapor barrier layer. Materials to be used for the barrier layer are not particularly limited, and a metal layer, a ceramics layer, and the like, are suitably used. Preferable examples of the inorganic material include metal materials such as aluminum, titanium, nickel, iron, platinum, gold, and silver; and ceramics materials such as silicon oxide, magnesium oxide, and aluminum oxide. It is preferable that the thickness of the barrier layer is, for example, 0.01 to 50 μm. In view of easiness in thermal welding, electrolyte resistance, and chemical resistance, a material for the resin layer disposed at the inner side of the housing is preferably a polyolefin such as polyethylene or polypropylene, polyethylene terephthalate, polyamide, polyurethane, polyethylene-vinyl acetate (EVA) copolymer, or the like. The thickness of the resin layer at the inner surface side is preferably 10 to 100 μm. In view of strength, shock resistance, and chemical resistance, the resin layer disposed at the outer surface side of the housing is preferably a polyamide such as 6,6-nylon; a polyolefin; and a polyester such as polyethylene terephthalate, polybutylene terephthalate, or the like. It is preferable that the thickness of the resin layer at the outer surface side is 5 to 100 μm.

### EXAMPLE 1

According to the following procedures, a thin cell including a pair of negative electrodes and a positive electrode sandwiched between the negative electrodes was produced, wherein each negative electrode is a single-sided electrode, and the positive electrode is a double-sided electrode.

### (1) Production of Negative Electrode

For a negative electrode current collector sheet, an 8 μm-thick electrolytic copper foil was prepared. Negative electrode mixture slurry was applied to one surface of the electrolytic copper foil, followed by drying, and then pressing the resulting product to form a negative electrode active material layer. Thus, a negative electrode sheet was obtained. The negative electrode mixture slurry was prepared by mixing 100 parts by mass of graphite (average particle diameter: 22 μm) as a negative electrode active material, 8 parts by mass of polyvinylidene-fluoride (PVdF) as a binder, and an appropriate amount of N-methyl-2-pyrrolidone (NMP) with each other. The thickness of the negative electrode active material layer was 145 μm. An 18 mm×48.5 mm negative electrode having 6 mm×7 mm negative electrode tab was cut out from the negative electrode sheet, and an active material layer was peeled off from the negative electrode tab to expose the copper foil. Thereafter, a negative electrode lead made of copper was ultrasonically welded to a 1.4 mm-width tip end of the negative electrode tab.

To the negative electrode tab, three slits were formed in a direction intersecting at 90° to the extending direction thereof so as to form a flat first spring structure that expands and contracts in the extending direction. Specifically, a linear opening, having a length of 4.5 mm and extending from a first end to a second end side at the outer side in the width direction of the negative electrode tab, was formed in positions at 2.5 mm and 6.5 mm from the top end of the negative electrode tab. Furthermore, a linear opening, having a length of 4.5 mm and extending from the second end to the first end side, was provided in position at 4.5 mm from the upper end of the negative electrode tab.

### (2) Production of Positive Electrode

For a positive electrode current collector sheet, a 15 μm-thick aluminum foil was prepared. Positive electrode mixture slurry was applied to both surfaces of the aluminum foil, followed by drying, and then pressing the resultant product to form a positive electrode active material layer. Thus, a positive electrode sheet was obtained. The positive electrode mixture slurry was prepared by mixing 100 parts by mass of LiNi_{0.8}Co_{0.16}Al_{0.4}O₂ (average particle diameter: 20 μm) as a positive electrode active material, 0.75 parts by mass of acetylene black as the conductive agent, 0.75 parts by mass of PVdF as a binder, and an appropriate amount of NMP. The thickness (for each surface) of the positive electrode active material layer was 80 μm. A 16 mm×46.5 mm positive electrode having a 6 mm×8 mm tab was cut out from the positive electrode sheet, and an active material layer was peeled off from the positive electrode tab to expose the aluminum foil. Thereafter, a positive electrode lead made of aluminum was ultrasonically welded to a 1.5 mm-width tip end portion of a positive electrode tab.

The positive electrode tab was provided with three slits similar to those of the negative electrode so as to form a flat first spring structure that expands and contracts in the extending direction. Specifically, a linear opening, having a length of 4.5 mm and extending from a first end to a second end side of the outer side in the width direction of the positive electrode tab, was formed in positions at 2.5 mm and 7.5 mm from the upper end of the positive electrode tab. Furthermore, a linear opening, having a length of 4.5 mm and extending from the second end to the first end side, was formed a in position at 5.0 mm from the top end of the negative electrode tab.

### (3) Non-Aqueous Electrolyte

A non-aqueous electrolyte was prepared by dissolving LiPF₆ in a mixed solvent of ethylene carbonate (EC), ethyl methyl carbonate (EMC) and diethyl carbonate (DEC) at a concentration of 1 mol/L (volume ratio of 20:30:50).

### (4) Assembling of Thin Cell

To 100 parts by weight of the above-mentioned mixed solvent, 5 parts by weight of PVdF was dissolved to prepare a polymer solution. The resulting polymer solution was applied to the both surfaces of the separator made of 18 mm×50 mm microporous polyethylene film (thickness: 9 μm), and then, the solvent was vaporized to form a PVdF film. The amount of applied PVdF was 15 g/m². Thereafter, a positive electrode was disposed between the pair of negative electrodes with a separator interposed therebetween such that a negative electrode active material layer and a positive electrode active material layer face each other. Thus, a stacked electrode assembly was formed.

Next, an electrode assembly was housed in a pipe-shaped housing formed of a laminate film (thickness 85 μm) including a barrier layer of aluminum, an inner layer of polypropylene, and outer layer of nylon. The positive electrode lead and the negative electrode lead were derived from one opening of the housing, each lead was surrounded by a thermoplastic resin as a seal member. Then, the opening was sealed by thermal welding. Then, the non-aqueous electrolyte was injected into the housing from the other opening, and the other opening was thermally welded under reduced pressure of −650 mmHg. Thereafter, the cell was subjected to aging in an environment at 45° C., and the entire electrode assembly was impregnated with the non-aqueous electrolyte. Finally, the cell was pressed at a pressure of 0.25 MPa for 30 seconds at 25° C. to produce cell A1 having a thickness of 0.7 mm.

### [Evaluation]

### Initial Cell Capacity

Cell A1 was charged and discharged as follows in an environment at 25° C., and initial capacity (C₀) was obtained. Herein, the design capacity of cell A1 is 1 C (mAh).
(1) Constant current charge: 0.2 CmA (final voltage: 4.2 V)
(2) Constant voltage charge: 4.2 V (final electric current: 0.05 CmA)
(3) Constant current discharge: 0.5 CmA (final voltage: 2.5 V)

### Capacity Retention Rate After Bending Test

A pair of fixing members capable of expanding and contracting were horizontally disposed to face each other. The portions at both ends of the discharged cell A1, which had been closed by thermal welding, were fixed by the fixing members. Then, in an environment at a temperature of 25° C., a jig having a curved portion whose radius of curvature R was 15 mm was pressed onto the cell, the cell was curved along the curved portion, then the jig was separated from the cell, and the cell regained its original form. This operation was repeated 10,000 times. Thereafter, the thin cell was charged and discharged in the same conditions as mentioned above to obtain discharge capacity (Cx) after the bending test. The capacity retention rate was calculated from the obtained discharge capacity Cx and initial capacity C₀ based on the following formula.

Capacity retention rate after bending test (%)=(Cx/C₀)×100

Ten cells A1 were produced and subjected to the similar tests, respectively, and an average value of the capacity retention rates was calculated. Results are shown in Table 1.

### COMPARATIVE EXAMPLE 1

Ten cells B1 were produced in the same manner as in Example 1 except that a slit was not formed in the positive electrode tab and the negative electrode tab, and the produced cells were evaluated. Results are shown in Table 1.

TABLE 1

| | | Capacity |
|---|---|---|
| | Initial | retention |
| | capacity | rate |
| | (mAh) | (%) |
| Cell Al | 70 | 100 |
| Cell B1 | 70 | 60 |

As shown in Table 1, the high capacity retention rate is obtained in Example 1 in which a tab has a spring structure, while the capacity retention rate is largely decreased in Comparative Example 1 in which a tab does not have a spring structure. This is because in four cells B1 of ten cells, the tab was broken and the capacity was not obtained.

### EXAMPLE 2

A negative electrode sheet having negative electrode active material layers on both surfaces of an electrolytic copper foil was used, and three slits were formed in a negative electrode tab in the same manner as in Example 1 to obtain a negative electrode having a first spring structure. On both surfaces of the negative electrode, positive electrodes were disposed with a separator interposed therebetween, respectively. Then, a pair of negative electrodes each having a negative electrode active material layer on one surface of an electrolytic copper foil were disposed thereon with a separator interposed therebetween such that the negative electrode active material layer and the positive electrode active material layer face each other to form a stacked electrode assembly. Except for this point, cell A2 having a thickness of 1.1 mm and having a spring structure in the positive electrode tab and the negative electrode tab was produced and evaluated in the same manner as in as in Example 1.

### EXAMPLE 3

Polyethylene films having a size of 6 mm×6 mm (thickness: 20 μm) were thermally welded to both surfaces of the positive electrode tab at a position 2.0 mm from the upper end of the positive electrode tab, and three slits were formed. Polyethylene films having a size of 6 mm×5 mm (thickness: 20 μm) were also thermally welded to both surfaces of the negative electrode tab at a position 2.0 mm from the upper end of the negative electrode tab and three slits were formed. Thus, ten cells A3 were produced and evaluated in the same manner as in Example 2 except that the slit part was covered with a polyethylene film.

### COMPARATIVE EXAMPLE 2

Ten cells B2 were produced and evaluated in the same manner as in Example 2 except that slits were not formed on both of the positive electrode tab and the negative electrode tab. Results are shown in Table 2.

TABLE 2

| | | Capacity |
|---|---|---|
| | | retention rate |
| | Initial | after |
| | capacity | bending test |
| | (mAh) | (%) |
| Cell A2 | 140 | 90 |
| Cell A3 | 140 | 100 |
| Cell B2 | 140 | 10 |

As shown in Table 2, while cells A2 and A3 in which a tab is provided with a spring structure have a high capacity retention rate, the capacity retention rate is largely decreased in Comparative Example 2 in which a tab is not provided with a spring structure. In cells A2, A3 and B2 in which the number of stacks is increased, in a bending test, a load to the tabs becomes larger in the positive electrode and the negative electrode positioned at the outermost surface as compared with cells A1 and B1. Therefore, in Comparative Example 2 in which the tab is not provided with a spring structure, in eight of ten cells B2, the tab was broken and capacity was not obtained. In cells A2 and A3 in which the tab is provided with a tab, breaking of the tab was not observed, but in cell A2, the capacity retention rate was slightly decreased with an increase in resistance due to occurrence of cracks. On the other hand, in cell A3 in which a spring structure portion was covered with a resin film, no cracks occurred and high capacity retention rate was achieved.

A thin cell of the present invention is suitable for use in a small electronic equipment such as a biological wearable device or a wearable portable terminal.

1. A thin cell comprising:
a sheet-like electrode assembly;
a non-aqueous electrolyte with which the electrode assembly is impregnated, and
a housing for hermetically housing the electrode assembly and the non-aqueous electrolyte,
wherein
the electrode assembly includes:
a sheet-like first electrode,
a sheet-like second electrode, and
a separator disposed between the first electrode and the second electrode,
the first electrode includes a first current collector sheet, and a first active material layer attached to a surface of the first current collector sheet,
the second electrode includes a second current collector sheet, and a second active material layer attached to a surface of the second current collector sheet,
at least one of the first current collector sheet and the second current collector sheet correspondingly has a first tab extending from a part of one side of the first current collector sheet in a plane direction of the first current collector sheet, or a second tab extending from a part of one side of the second current collector sheet in a plane direction of the second current collector sheet, and
at least one of the first tab and the second tab forms a first spring structure that expands and contracts in an extending direction of the at least one of the first tab and the second tab.

2. The thin cell according to claim 1, wherein at least one of the first tab and the second tab further correspondingly includes a first lead connected to the first tab and led out to outside of the housing, or a second lead connected to the second tab and led out to outside of the housing.

3. The thin cell according to claim 1, wherein at least one of the first tab and the second tab correspondingly includes a multiple-line structure including a plurality of conductive paths for allowing the first current collector sheet and the first lead to have electrical continuity to each other, or a multiple-line structure including a plurality of conductive paths for allowing the second current collector sheet and the second lead to have electrical continuity to each other.

4. The thin cell according to claim 2, wherein at least one of the first lead and the second lead forms a second spring structure.

5. The thin cell according to claim 1, wherein a part of the first tab and a part of the second tab form at least one of a first lead portion led out to outside of the housing, and a second lead portion led out to outside of the housing.

6. The thin cell according to claim 1, wherein at least one of the first current collector sheet and the first tab, and the second current collector sheet and the second tab, have a seamless structure cut out from one conductive sheet material.

7. The thin cell according to claim 1, wherein the first spring structure is formed by a slit provided in at least one of the first tab and the second tab, and the slit is formed in a direction intersecting an extending direction of the at least one of the first tab and the second tab.

8. The thin cell according to claim 1, wherein at least one of the first tab and the second tab further includes a resin film covering at least a part of the first tab or the second tab.

9. The thin cell according to claim 1, wherein at least a part of the non-aqueous electrolyte forms a gel electrolyte, and
the gel electrolyte bonds between the first active material layer and the separator, and between the second active material layer and the separator.

10. A thin cell comprising:
a sheet-like electrode assembly;
a non-aqueous electrolyte with which the electrode assembly is impregnated, and
a housing for hermetically housing the electrode assembly and the non-aqueous electrolyte,
wherein
the electrode assembly includes:
a sheet-like first electrode,
a sheet-like second electrode, and
a separator disposed between the first electrode and the second electrode, and
at least one of a first lead connected to the first electrode and extending to outside of the housing, and a second lead connected to the second electrode and extending to outside of the housing,
the first electrode includes a first current collector sheet and a first active material layer attached to a surface of the first current collector sheet,
the second electrode includes a second current collector sheet and a second active material layer attached to a surface of the second current collector sheet, and
at least one of the first lead and the second lead forms a second spring structure that expands and contracts in an extending direction of the at least one of the first lead and the second lead.

11. A cell-mounting device comprising the thin cell according to claim 1, and flexible electronic equipment driven by supply of electric power from the thin cell, wherein the thin cell and the electronic equipment are integrated together to form a sheet.

12. A cell-mounting device comprising the thin cell according to claim 10, and flexible electronic equipment driven by supply of electric power from the thin cell, wherein the thin cell and the electronic equipment are integrated together to form a sheet.
